(19) United States
(12) Patent Application Publication
(10) Pub. No.: US 2007/0072491 A1
(43) Pub. Date: Mar. 29, 2007

(54) Integrated signal connecting port

(75) Inventor: Jung Hung Huang, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/366,474

(22) Filed: Mar. 3, 2006

(30) Foreign Application Priority Data
Sep. 27, 2005 (TW) 094133494

(51) Int. Cl. H01R 24/00

(52) U.S. Cl. 439/660

(57) ABSTRACT

An integrated signal connecting port includes a main body, a socket portion disposed at a front end of the main body, a surrounding portion disposed by surrounding a part of the socket portion, an upper trench set disposed at a upper surface of the socket portion and communicating to a rear end of the main body, a lower trench set disposed at a lower surface of the socket portion and communicating to the rear end of the main body, a first terminal set inlayed in the upper trench set, and a second terminal set inlayed in the lower trench set. The first terminal set is functioned as the socket compatible with a signal plug defined by Universal Serial Bus standard.

This Non-provisional application claims priority under 35 U.S.C. §119(a) on Patent Application No(s). 094133494 filed in Taiwan, Republic of China on Sep. 29, 2005, the entire contents of which are thereby incorporated by reference.

### 1. FIELD OF THE INVENTION

The present invention relates to a signal connecting port, and more particularly to an integrated signal connecting port for adapting two types of signal plugs that comply with different specifications.

### 2. DESCRIPTION OF RELATED ART

With development of the Universal Serial Bus (USB), it has been widely used as an interface between a computer and its peripherals. By using a 4-pins USB connector (2 pins are for power supply, and the other two pins are for signals transmission), the computer can not only exchange information with the peripherals via signal pins but also provide them electric power at the same time.

Up to now, for allowing electronic devices, such as digital cameras, digital video cameras and etc., to be connected to a computer system or a monitor directly, a specification known as mini-B USB connector with smaller size is further developed based on the USB connector. The specification of mini-B USB connector defines a signal connector 10 having 5 pins as shown in FIG. 1. Such a 5-pins signal connector defines a fifth pin for deciding which one is a host end among the two ends connected therewith while the other four pins are defined as ordinary USB connectors with 2 pins for power supply and 2 pins for signal communication. In addition, for further reducing the size of electronic devices, several analog signals or digital signals will be integrated with USB signals into the same signal connecting port 20. As FIG. 2 shows, in the conventional integrated signal connecting port 20 having 8 pins, the sixth to eighth pins are used for transmitting AV signals so as to substitute for a traditional AV connector. And the first to the fifth pins have same functions as the pins defined in the mini-B USB connector mentioned above.

However, the layouts of both signal connectors mentioned above are quite different as shown in FIG. 1 and FIG. 2, only specific transmission cable and signal plug can be used with a specific specification of signal connecting port. A transmission cable and signal plug for one type of signal connecting port can not be used with the other type of signal connecting port. For example, the integrated signal connecting port 20 has 8 pins separated into upper and lower rows with 4 pins in each row. The signal plug used to match the integrated signal connecting port 20 can not be used with the mini-B USB connector 10 that has only five pins arranged in one single row. Accordingly, a user must use a specific signal plug for a specific signal connecting port and is unable to use only one signal plug in every signal connecting ports with different pin arrangement. This causes users a lot of inconvenience.

### SUMMARY OF THE INVENTION

Therefore, one object of the present invention is to provide an integrated signal connecting port which is provided with a first terminal set conformed to an industry standard and a second terminal set for other functions.

In addition, another object of the present invention is to provide a signal plug used for being plugged in the integrated signal connecting port of the present invention.

For attaining the objects mentioned above, the present invention provides an integrated signal connecting port that includes a main body; a socket portion disposed at a front end of the main body; a surrounding portion disposed by surrounding a part of the socket portion; an upper trench set disposed at the upper surface of the socket portion and communicating to the rear end of the main body; a lower trench set disposed at a lower surface of the socket portion and communicating to the rear end of the main body; a first terminal set inlayed in the upper trench set; and a second terminal set inlayed in the lower trench set. The first terminal set is functioned as the socket compatible with a signal plug defined by Universal Serial Bus (USB) standard.

In one preferred embodiment, the upper and the lower trench sets are each constituted by a plurality of trenches matching the number of pins of the terminal set. The front end of each pin in the first and second terminal is inserted and fixed at the front end of a corresponding trench, and the rear end thereof extends out of the rear end of the trench. The first terminal set can be constituted by 5 pins, and installed to match a signal plug defined by a specification of mini-B USB connector. The second terminal set is constituted by 4 pins and used for transmitting AV signals.

According to another object of the present invention, the present invention provides a signal plug used for plugging in the integrated signal connecting port of the present invention. The integrated signal connecting port has a first terminal set and a second terminal set, the signal plug includes a first conducting set and a second conducting set each for being connected electrically with the first terminal set and the second terminal set, respectively. The first conducting set is compatible with a specification of mini-B USB connector.

### BRIEF DESCRIPTION OF THE DRAWINGS

The present invention can be more fully understood by reference to the following description and accompanying drawings, in which:

FIG. 1 is a perspective view showing a conventional mini-B USB connector with 5 pins;

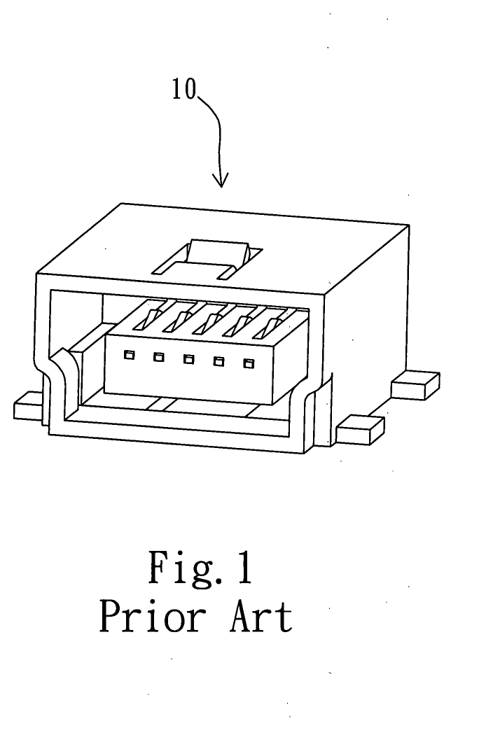

FIG. 2 is a perspective view showing a conventional integrated signal connecting port with 8 pins;

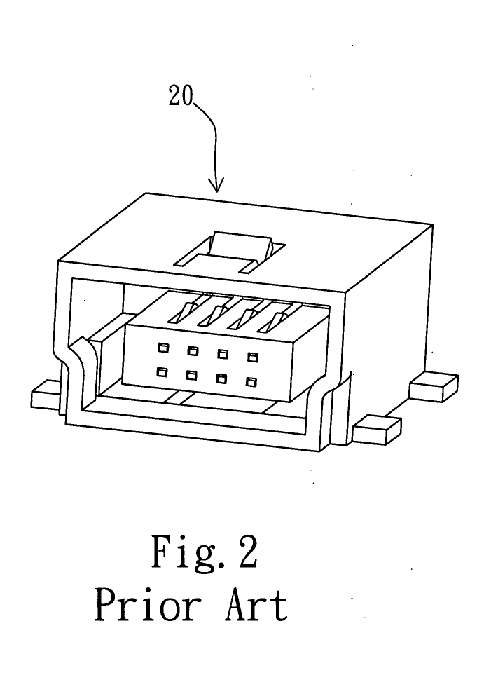

FIG. 3 is an exploded view showing an integrated signal connecting port according to one embodiment of the present invention;

FIG. 4 is a perspective view showing an assembled integrated signal connecting port shown in FIG. 3;

FIG. 5 is a cross sectional view showing an integrated signal connecting port shown in FIG. 3;

FIG. 6 is an exploded view showing an integrated signal connecting port according to another embodiment of the present invention in which a main body of the integrated signal connecting port is assembled with a housing;

FIG. 7 is a cross sectional view showing the integrated signal connecting port shown in FIG. 6, in which a signal plug with 5 pins is intended to be plugged in the integrated signal connecting port; and

FIG. 8 is a cross sectional view showing the integrated signal connecting port shown in FIG. 6, in which a signal plug with 9 pins is intended to be plugged in the integrated signal connecting port.

### DETAILED DESCRIPTION OF THE PREFERRED EMBODIMENTS

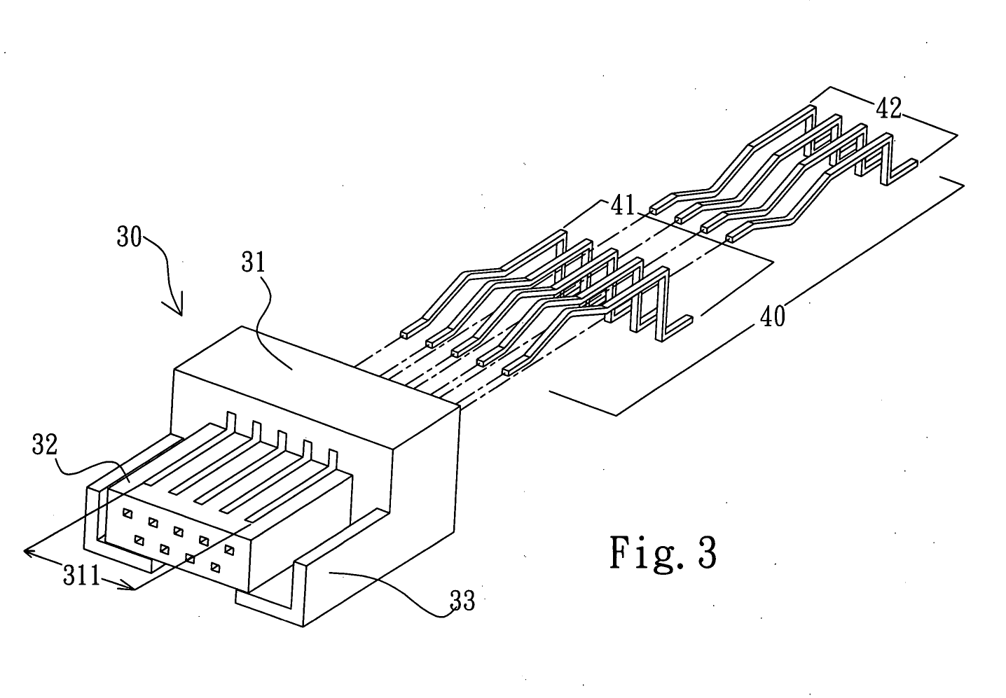

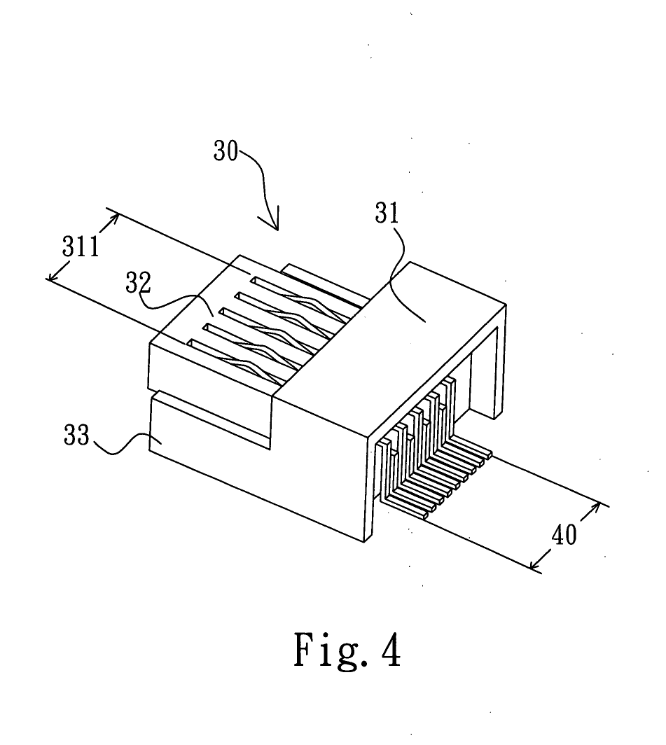

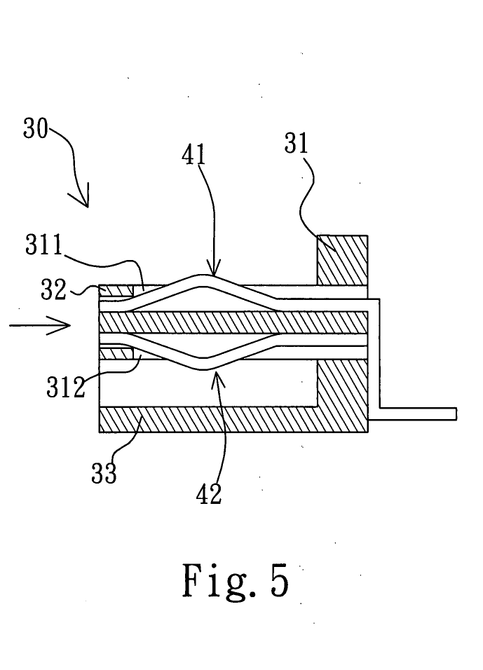

Please refer to FIGS. 3, 4, and 5. FIG. 3 is an exploded view showing an integrated signal connecting port according to one embodiment of the present invention, FIG. 4 is a perspective view showing the integrated signal connecting port shown in FIG. 3, and FIG. 5 is a cross sectional view showing the integrated signal connecting port shown in FIG. 3.

As the figures show, the integrated signal connecting port according to the present invention has a main body unit 30 and a terminal unit 40 used for transmitting signals. The main body unit 30 includes a main body 31, a socket portion 32 disposed at the front end of the main body 31, and a surrounding portion 33 surrounded around a part of the socket portion 32. Furthermore, a plurality of an upper and a lower trench sets 311 and 312 are respectively disposed on the upper and the lower surfaces of the socket portion 32 and communicating to the rear end of the main body 31 as shown in FIGS. 3 and 5. The number of the terminal trenches in the trench sets 311 and 312 depends on the number of the pins of the terminal unit to be matched therewith. In addition, the surrounding portion 33 surrounded a part of the socket portion 32 is similarly connected to the front end of the main body 31. Furthermore, an opening is disposed at the front end of the surrounding portion 33 for guiding a signal plug to be plugged into the socket part 32.

The terminal unit 40 used for transmitting signals has a first terminal set 41 for supplying electric power and transmitting information and a second terminal set 42 for transmitting AV signals. The pins of the first terminal set 41 and the second terminal set 42 are each inlayed in the upper trench set 311 and the lower trench set 312, respectively. The front end of each pin of the terminal unit 40 is plugged into the front end of the corresponding terminal trench, and the rear end thereof extends out of the rear end of the main body 31 (as FIG. 5 shows) for being welded on a wire or a printed circuit board (PCB). In the embodiment, for being matched with a signal plug with 5 pins as defined in the specification of mini-B USB connector, the first terminal set 41 has 5 pins for a user to use a signal plug of a conventional mini-B USB connector with the socket portion 32 to process information transmission and power supplying. And the second terminal set 42 is designed to be operated in coordination with the transmission of AV signals and constituted with 4 pins to substitute for conventional AV connectors to integrate the AV signals with conventional USB signals into a single signal plug.

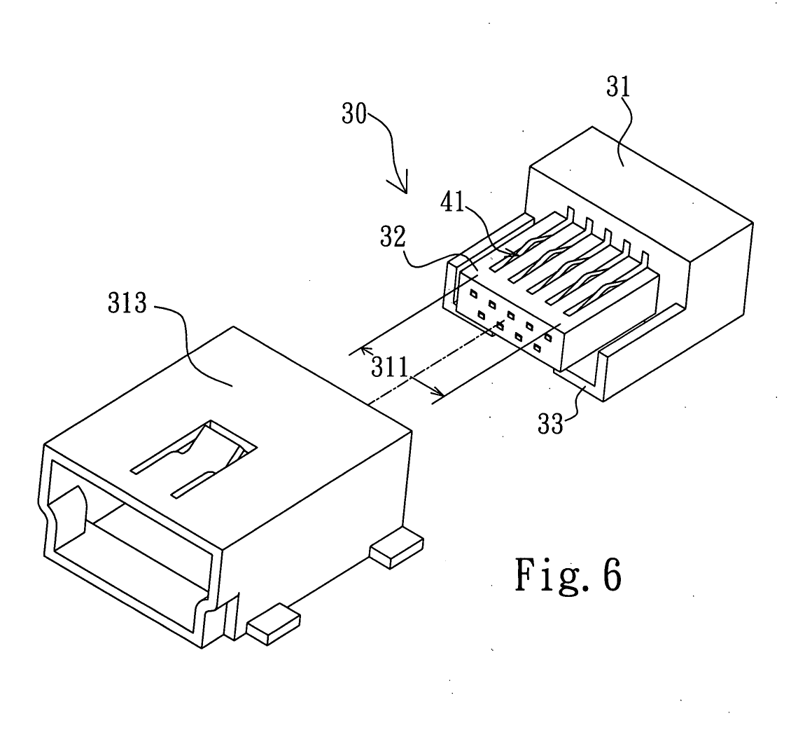

Please refer to FIG. 6. FIG. 6 is an exploded view showing an integrated signal connecting port according to another embodiment of the present invention in which a main body of the integrated signal connecting port is assembled with a housing. As FIG. 6 shows, the integrated signal connecting port according to the present invention can further have a housing 313 used for shielding the main body 31. The housing 313 covers the surface of the main body 31 for protecting the pins of first terminal set 41 and the second terminal set 42 from interference.

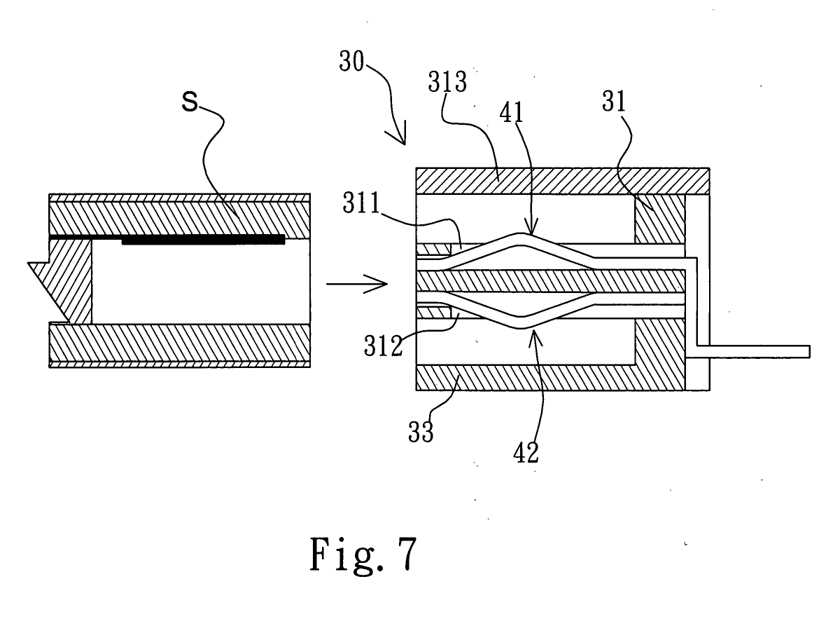

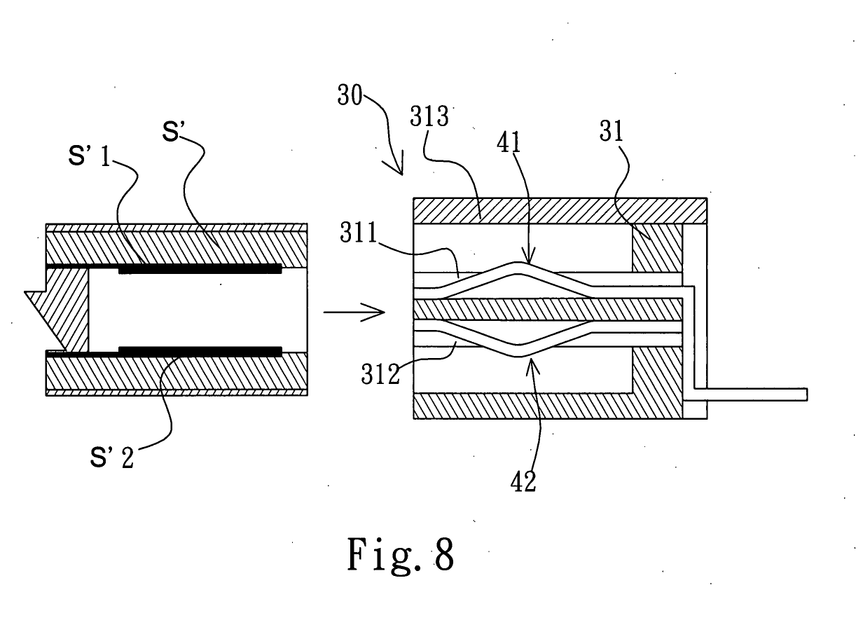

Please refer to FIGS. 7 and 8. FIG. 7 is a cross sectional view showing the integrated signal connecting port shown in FIG. 6, in which a signal plug with 5 pins is intended to be plugged in the integrated signal connecting port; and, FIG. 8 is a cross sectional view showing an integrated signal connecting port shown in FIG. 6, in which a signal plug with 9 pins is intended to be plugged in the integrated signal connecting port.

According to the integrated signal connecting port of the present invention, if a user only needs to use USB transmission function, the user can plug a conventional signal plug S with 5 pins defined by the specification of mini-B USB connector into the socket portion 32 of the integrated signal connecting port according to the present invention as shown in FIG. 7. Accordingly, each pin of the ordinary mini-B USB connector can be electrically connected with a corresponding pin of the first terminal set 41. If the user needs to further use AV signal transmitting function, the user can plug the signal plug S′ having conducting sets corresponding with 9 pins according to the present invention into the socket portion 32, as shown in FIG. 8. The signal plug S′ has a first conducting set S′1 and a second conducting set S′2 for being electrically connected respectively with the first terminal set 41 and the second terminal set 42. The first conducting set S′2 complies with the specification of mini-B USB connector. Therefore, the AV transmission and the USB function can be attained at the same time.

Because the arrangement of the first terminal set is compatible with currently wide-used signal plug defined by an industrial standard, the signal connecting port of the present invention is suitable for using with the transmission cables of this standard. It is convenient for a user to get an applicable transmission cable. Moreover, when AV signals are intended to be transmitted directly or the signals of the first and the second terminal sets are required to be used at the same time, the concurrent transmission of AV and USB signals can then be attained through the use of a signal plug and the signal connecting port according to the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An integrated signal connecting port, comprising:
a main body;
a socket portion disposed at a front end of said main body;
a surrounding portion disposed by surrounding a part of said socket portion;
an upper trench set disposed at the upper surface of said socket portion and communicating to a rear end of said main body;
a lower trench set disposed at the lower surface of said socket portion and communicating to said rear end of said main body;
a first terminal set inlayed in said upper trench set; and
a second terminal set inlayed in said lower trench set;
wherein said first terminal set is compatible with a signal plug defined by Universal Serial Bus standard.

2. The integrated signal connecting port according to claim 1, wherein said upper and lower trench sets are constituted by a plurality of trenches matching the number of pins of said first and second terminal sets.

3. The integrated signal connecting port according to claim 2, wherein the front end of each pin in said first and second terminal sets is inserted into and fixed at the front end of a corresponding trench in said upper and lower trench sets, and the rear end of said pin extends out of the rear end of said trench.

4. The integrated signal connecting port according to claim 1, which further comprises a housing.

5. The integrated signal connecting port according to claim 1, wherein said first terminal set is constituted by 5 pins.

6. The integrated signal connecting port according to claim 5, wherein said first terminal set is disposed to match a signal plug defined by a specification of mini-B USB connector.

7. The integrated signal connecting port according to claim 1, wherein said second terminal is constituted by 4 pins.

8. The connecting port according to claim 7, wherein said second terminal set is used for transmitting AV signals.

9. A signal connecting port, comprising:
a main body;
a socket portion disposed at the front end of said main body;
a first terminal set disposed in said socket portion; and
a second terminal set disposed in said socket portion;
wherein said first terminal set is compatible with a signal plug defined by an industrial specification.

10. The signal connecting port according to claim 9, wherein said first terminal set is disposed on a first surface of said socket portion, said second terminal set is disposed on a second surface of said socket portion.

11. The signal connecting port according to claim 10 further comprising:
a first trench set disposed at said first surface and communicating to a rear end of said main body; and
a second trench set disposed at said second surface and communicating to the rear end of said main body;
wherein said first terminal set is inlayed in said first trench set, and said second terminal set is inlayed in said second trench set.

12. The signal connecting port according to claim 11, wherein said first terminal set and said second terminal set each comprises a plurality of pins, and the front end of each pin is inlayed and fixed at the front end of a corresponding trench and the rear end of said pin extends out of the rear end of said trench.

13. The signal connecting port according to claim 9, which further comprises a housing.

14. The signal connecting port according to claim 9, wherein said first terminal set is constituted by 5 pins.

15. The signal connecting port according to claim 14, wherein said first terminal set is compatible with a signal plug defined by a specification of mini-B USB connector.

16. The signal connecting port according to claim 9, wherein said second terminal set is constituted by 4 pins and used for transmitting AV signals.

17. A signal plug for being plugged in a signal connecting port comprising a first and a second terminal sets, said signal plug comprises:
a first conducting set for being electrically connected with said first terminal set; and
a second conducting set for being electrically connected with said second terminal set;
wherein said first conducting set is compatible with an industrial specification.

18. The signal plug according to claim 17, wherein said first conducting set is compatible with a specification of Universal Serial Bus (USB).

19. The signal plug according to claim 18, wherein said first conducting set is compatible with a specification of mini-B USB connector.
